(19) United States
(12) Patent Application Publication
(10) Pub. No.: US 2026/0368816 A1
(43) Pub. Date: Nov. 19, 2026

(54) AUTOMATED WORKFLOWS FOR UTILITY ASSET EXCHANGES

(71) Applicant: Green Exchange, PBC, New York, NY (US)

(72) Inventors: Daniel Mark Labovitz, New York, NY (US); Charles Paul Dolan, Gladstone, NJ (US); Maria Mãhl, East Jewett, NY (US)

(21) Appl. No.: 19/683,605

(22) Filed: May 20, 2026

Related U.S. Application Data
(63) Continuation-in-part of application No. 19/680,642, filed on May 18, 2026.
(60) Provisional application No. 63/809,283, filed on May 20, 2025.
(60) Provisional application No. 63/807,469, filed on May 16, 2025.
(60) Provisional application No. 63/809,283, filed on May 20, 2025.

(51) Int. Cl. G06Q 40/04

(52) U.S. Cl. CPC G06Q 40/045

(57) ABSTRACT

Systems and methods for automated workflows for utility asset exchanges are provided herein. A utility asset may be created and issued by a developer system, which may then transfer the utility asset to a trust system. The utility asset may further be registered with the trust system and translated into shares. The trust system may communicate the information regarding the shares to a platform server that maintains an online order book that tracks status of the shares linked to the utility asset. The platform server may further automatically initiate removal of the shares from the trust system when the tracked status of the shares indicates redemption of the utility asset.

### CROSS-REFEREND TO RELATED APPLICATIONS

The present patent application claims the priority benefit of U.S. provisional patent application 63/809,283 filed May 20, 2025 and is a continuation-in-part of U.S. nonprovisional patent application 19/680,642 filed May 18, 2026, which claims the priority benefit of U.S. provisional patent application number 63/807,469 filed May 16, 2025 and U.S. provisional patent application number 63/809,283 filed May 20, 2025, the disclosures of each of the foregoing are incorporated by reference herein.

### BACKGROUND OF THE INVENTION

### 1. Field of the Disclosure

The present invention generally relates to automated workflows for asset exchanges. More specifically, the present invention relates to automated workflows for on utility assets and coordinating utility asset exchanges.

### 2. Description of the Related Art

Utility assets may be defined and tracked using digital data files that reflect a set of rights (e.g., non-security contractual right to receive certain real-world benefits) that can be collateralized and therefore be treated and have value as intangible assets. The data associated with the contractual right may vary (e.g., depending on the type of benefit conferred by the set of rights). The term “utility” in this context refers to real-world uses and application other than financial value, as distinguished from a financial asset (e.g., security such as a share or bond) whose only intrinsic value is monetary. Thus, the utility asset may be similar to a tradable commodity (e.g., cotton or soybeans), which may be traded using instruments representing the asset without any intention to take delivery. As a result, end-user systems can conduct online trades using the same instrument for the purpose of securing delivery of the physical commodity. Unlike a commodities market, however, online platforms for exchanging utility assets are typically not regulated, and exchange rules may not be standardized, with each platform implementing its own rules for how to list (register) and trade assets thereon.

Further, utility assets may be issued by a developer framework capable of generating or creating the asset, registered and tracked on a registry managed by a registrar, and retired or removed from the registry once used to prevent double use. There are no presently available systems, however, that allow for utility asset exchanges while also tracking usage/consumption of the underlying utility asset and associated redemption/removal from the associated registries.

There is, therefore, a need in the art for improved systems and methods of automated workflows for utility asset exchanges.

### SUMMARY OF THE CLAIMED INVENTION

Embodiments of the present disclosure include systems and methods for automated workflows for utility asset exchanges. A utility asset may be created and issued by a developer system, which may then transfer the utility asset to a trust system. The utility asset may further be registered with the trust system and translated into shares. The trust system may communicate the information regarding the shares to a platform server that maintains an online order book that tracks status of the shares linked to the utility asset. The platform server may further automatically initiate removal of the shares from the trust system when the tracked status of the shares indicates redemption of the utility asset.

### BRIEF DESCRIPTION OF THE DRAWINGS

FIG. 1 illustrates an exemplary network environment in which systems for automated workflows for utility asset exchanges may be implemented

FIG. 2 is a flowchart illustrating an exemplary method of automated workflows for utility asset exchanges.

FIG. 3 illustrates an exemplary computing system hat may be used to implement an embodiment of the present invention.

### DETAILED DESCRIPTION

Embodiments of the present invention pertain to automated workflows for utility asset exchanges. A utility asset may be created and issued by a developer system, which may then transfer the utility asset to a trust system. The utility asset may further be registered with the trust system and translated into shares. The trust system may communicate the information regarding the shares to a platform server that maintains an online order book that tracks status of the shares linked to the utility asset. The platform server may further automatically initiate removal of the shares from the trust system when the tracked status of the shares indicates redemption of the utility asset. The automated workflows thus include synchronized redemption and registry retirement from the associated registries, as well as automatic share cancellation and proof-of-retirement issuance.

As used herein, a utility asset may include any type of non-security asset that have practical utility value for end-users and can later be redeemed, retired, or consumed. Exemplary utility assets may include (i) carbon credits such as Internationally Transferrable Mitigation Outcomes (Paris Agreement Article 6 carbon credits or “ITMOs"), Inflation Reduction Act tax incentive credits (“IRA credits”), renewable power purchase agreements (“PPAs"), biodiversity offset credits, and water usage rights. In the case of ITMOs and biodiversity credits, the project developer system may create the credits by setting aside property as protected land and limit the development of that land. The data associated with ITMOs and biodiversity credits is related to the properties set aside for conservation and the characteristics necessary to create the credits (e.g., the number of trees or types of habitat preserved). A third party system may verify that the appropriate protections are in place, and certify a number of credits that are generated by protecting the property. Either the developer or a third-party systems may operate a registrar for the credits, tracking the credits (e.g., on an online registry) to ensure that the credits are not double-counted when sold and used. When an end purchaser system initiates usage or exercise of a credit, the registrar may automatically cancel the credit on the registry and issue a certificate confirming that the credit has been removed from the registry. Used credits cannot be transferred to another purchaser.

In the case of PPAs and water usage rights, the end purchaser system may have the right to receive a metered commodity (e.g., electrical power generated by the renewable power generation facility, or an allocation of a certain number of gallons/acre-feet of water, respectively). The developer system may sell the right to receive the commodity and may maintain a registry of delivery obligations and usage, represented as credits in the registry and cancellations of the credits as the credits are used. Purchaser systems may draw down the credits at their option.

In the case of an IRA credits, the end purchaser system may be associated with a taxpayer user seeking to offset tax liabilities by applying a previously generated tax credit. Tax credits may be generated as a result of investments in the construction of qualifying physical assets (e.g., renewable or clean energy power generation facilities; carbon capture and removal facilities; etc.). The developer of the project must satisfy the conditions of the IRA to generate the tax credits, which the developer may either claim to offset its own tax liabilities, or sell to a qualified tax equity investor at a discount to the value of the credit (which enables the tax equity investor to profitably offset its tax liabilities). Developers by way of automated systems may sell the tax credits as financing to construct the qualifying asset. The developer system may thus track the development of the project to ensure that it satisfies the conditions of the IRA necessary to generate tax credits, and may collect and file various records and data (e.g., with the IRS) in connection with the transfer. The developer system may also track the identities of the tax equity investors and their qualifications to use the tax credits.

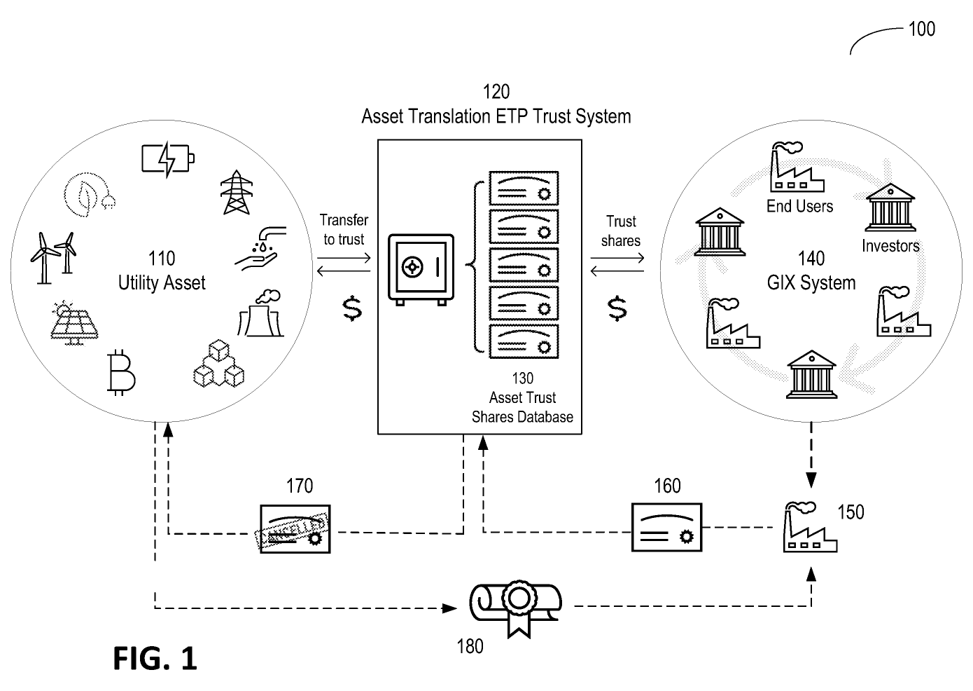

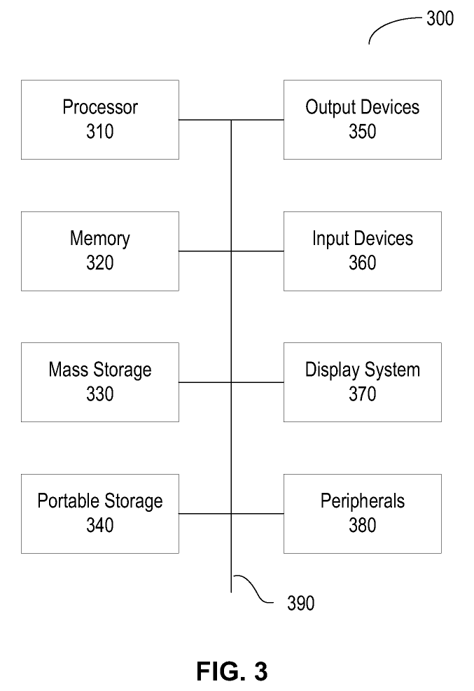

FIG. 1 illustrates an exemplary network environment 100 in which systems for automated workflows for utility asset exchanges may be implemented. As illustrated, network environment 100 may include utility asset data store 110, asset translation exchange-traded product (ETP) trust system 120 including an asset trust shares data store 130, and GIX system 140. Each of the devices and systems may be implanted as a computing system described in further detail in relation to FIG. 3 and may communicate with each other device or system using communication interfaces configured to communicate over communication networks.

Utility asset data store 110 may be associated with a developer system that may or may not be integrated with asset translation ETP trust system 120. Utility asset data store 110 includes any variety of database storage and memory used to maintain information regarding utility assets, including type of utility asset, measured utility production, quantified units, and standardized unit definitions. Utility asset data store 110 may also be associated with a registry or other tracking system that tracks information for each utility asset, including unique asset identifiers, ownership information (which may be updated as new ownership information is received) and status of usage/redemption. As such, records maintained by utility asset data store 110 for each utility asset may be used to confirm and verify asset validity, chain of custody, provenance, audit records, ownership transfer authorization, usage/redemption/retirement, and authorization for updates to the same.

As noted above, utility asset data store 110 may be part of, in communication, or otherwise associated with developer or issuing systems that define or create the underlying utility asset provided to end-user systems designated by ownership information. The utility asset data store 110 may include a registry database system be used to record the existence of the utility asset and current owner. Once a utility asset is created and a record of its creation is entered into the utility asset data store 110 or other asset registry, therefore, current and changed ownership and usage status of utility asset can tracked over time.

Utility asset data store 110 may be responsible for tracking the issuance and lifespan of utility assets. In the case of ITMOs, the utility asset data store 110 may be associated with registrar systems operated or associated with the issuer of the carbon credits (e.g., a sovereign nation or governmental unit), or by a third-party hired by the issuer. In the case of renewable power purchase agreements, the power generator may maintain the registry of credit holders, while water rights are typically managed by governmental entities. Tax credits are typically maintained by the developer system rather than in an official registry, governed by complex bespoke contracts (governed by the IRA).

Asset translation ETP trust system 120 (or SAFE trust system) may manage data records (e.g., in asset trust shares database 130) associated with conversion of a utility asset into exchange-traded shares and coordinate synchronization between exchange data and redemption data. Upon receipt of utility asset information from utility asset data store 110, asset translations ETP trust system 120 may translate the information into shares based on the quantified values (e.g., unit, unit definition, equivalence value) of the utility asset. Each translated share may represent a fractional interest and proportional quantity of a given utility asset. When the utility assets are transferred to a trust, the asset registry data in utility asset data store 110 may be updated to reflect the trust as the owner of the assets, while asset translation ETP trust system 120 analyzes the received data to create new data records reflecting the shares translated from the received utility asset data and store the new data records regarding the shares in asset trust shares database 130. In some implementations, asset trust shares database 130 may include, included in, operate in conjunction, or otherwise be associated with utility asset data store 110.

When shares of the trust (a new security) may be created with concurrent data records in asset trust shares database 130, the share may further be registered (e.g., with the SEC) and offered in a private or public share offering. Shareholders of the trust would own an undivided interest in the trust’s assets, but would not be individually listed in the asset registry until the shareholders converted their shares into the underlying utility asset using the process described herein. In that case, the trust’s ownership interest in the utility assets as shown on the asset registry would be reduced by the amount of the conversion.

In some implementations, asset translation ETP trust system 120 may issue the trust shares via IPO, where each share may represent a defined (e.g., quantified) set of rights to GIX system 140 for listing and trade exchanges among end-user systems. GIX system 140 may thus be responsible for coordinating such functions as operating as the regulated exchange for share trading, maintaining and publishing the primary order book for the shares, and serving as an authoritative source of truth for market state and order book information. For example, when ownership of the shares may be transferred from the trust, current ownership data may be provided from GIX system 140 to utility asset data store 110 and/or asset trust shares database 130

The end-user system 150 may thereafter tender 160 some or all of the associated shares to the trust, which may then automatically cancel 170 the share(s) and notifies the registrar (e.g., utility asset data store 110) to cancel an equivalent amount of the utility asset, which may thereafter be applied by the end-user system 150. For example, the tender 160 from end-user system 150 may be a redemption of the utility asset (e.g., carbon credit). The redemption or tender 160 may automatically trigger removal of the shares associated with the utility asset from asset trust shares database 130, as well as trigger removal of the utility asset from utility asset data store 110. As such, the equivalence relationship between the shares and utility asset may be preserved, and double usage/redemption may be prevented. Finally, the share exchange data may be synchronized to the utility asset retirement data.

The workflow may be implemented in a network environment that includes one or more communication networks that allow communication between the different systems, platforms, and devices associated with performance of the steps described. The communication networks may include local, proprietary networks (e.g., intranet) and/or may be a part of a larger wide-area network. The communications network may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network allows for communication between the various components of network environment.

Different electronic systems, platforms, and devices that may be used to perform at least part of the steps described herein may be inclusive of servers, general purpose computers, mobile phones, smartphones, personal digital assistants (PDAs), portable computing devices (e.g., laptop, netbook, tablets), desktop computing devices, handheld computing device, or any other type of computing device capable of communicating over communication network. The systems, platforms, and devices may also be configured to access data from other storage media, such as memory cards or disk drives as may be appropriate in the case of downloaded services. The systems, platforms, and devices may include standard hardware computing components such as network and media interfaces, non-transitory computer-readable storage (memory), and processors for executing instructions that may be stored in memory such as described in relation to FIG. 3. The functionalities of multiple servers may be integrated into a single server, or certain functions may be distributed across multiple servers. Any of the aforementioned servers (or an integrated server) may take on certain client-side, cache, or proxy server characteristics. These characteristics may depend on the particular network placement of the server or certain configurations of the server.

The steps may be embodied as executable instructions embodied in a non-transitory computer readable storage media. The instructions of the storage medium may be executed by a processor (or processors) to cause various hardware components of a computing device hosting or otherwise accessing the storage medium to effectuate the method. The steps discussed herein (and the order thereof) are exemplary and may include various alternatives, equivalents, or derivations thereof including but not limited to the order of execution of the same.

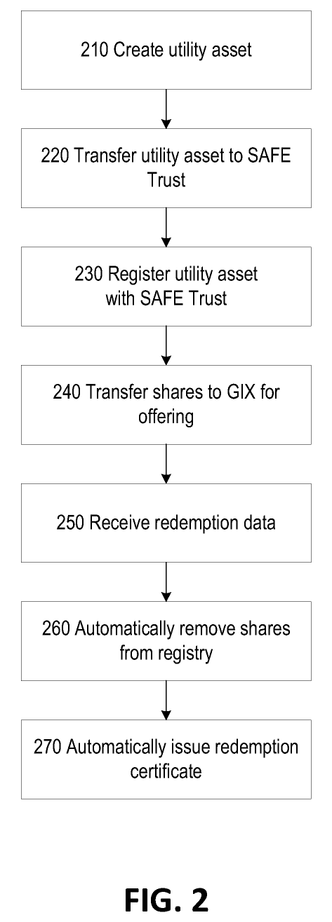

FIG. 2 is a flowchart illustrating an exemplary method of automated workflows for utility asset exchanges. As illustrated, a new utility asset may be created with data records (e.g., stored in utility asset data store 110) reflecting the particular details associated with that utility asset. The utility asset may be transferred into a trust and managed by a trust system (e.g., asset translation ETP trust system 120), which creates shares and associated data records (e.g., stored in asset trust shares database 130). The shares may be transferred using a trading platform (e.g., GIX system 140), where ownership transfers may be documented. When an end-user system associated an owner of one or more of the shares provides redemption data, the respective data records of the registry (e.g., utility asset data store 110) and trust (e.g., asset translation ETP trust system 120) may be automatically triggered to update and/or remove some or all of the shares and portions of the utility asset. In addition, a redemption certificate may be automatically issued to the end-user device in accordance with the workflow.

In step 210, a utility asset may be created. In some implementations, the utility asset 110 may be created by a developer system. Exemplary types of utility assets include carbon offset generation, renewable energy production, water rights creation, and sustainability project outputs. The utility asset may be associated with measured utility production, quantified units, created fungible asset records, and standardized unit definitions (e.g., one carbon credit = one metric ton CO₂ offset).

In step 220, the utility asset data may be transferred to a trust system (e.g., associated with a SAFE trust) such as asset translation ETP trust system 120. In some implementations, asset translation ETP trust system 120 may further undertake automated workflows to analyze the utility asset data to confirm authenticity, ownership status, transferability, redemption/retirement status, and synchronization with registry records (e.g., utility asset data store 110).

In step 230, the utility asset data may be registered within the asset translation ETP trust system 120. Registration may include converting the real-world utility asset into exchange-tradable SAFE trust shares while preserving the underlying utility value. The asset translation ETP trust system 120 may determine an equivalence ratio for translating the utility asset data into shares and may create new shares uniquely linked and corresponding to the specific utility asset. Asset translation ETP trust system 120 may also undertake automated workflows for registration of the shares (e.g., with concurrent data stored in asset trust shares database 130).

In step 240, the shares may be transferred to a trading platform (e.g., GIX system 140) where exchanges involving one or more of the shares may generate new ownership information reflecting a new owner (e.g., associated with end-user system 150). In some implementations, GIX system 140 may provide the transfer and/or ownership information to utility asset data store 110 and/or asset trust shares database 130.

In step 250, end-user system 150 may submit redemption data 160 to asset translation ETP trust system 120, which may automatically trigger steps 260 and 270 in which the shares are automatically removed or cancelled 170 from applicable registries and a redemption certificate automatically issued to document the same. Redemption enables the end-user system 150 to convert exchange-traded trust shares back into usable utility rights, consume or retire the underlying utility asset, and obtain proof of that retirement. For example, carbon credits may be retired to claim emissions offsets, renewable energy purchase rights may be exercised, or water usage entitlements may be used. .

FIG. 3 illustrates an exemplary computing system 300 that may be used to implement an embodiment of the present invention. The computing system 300 of FIG. 3 includes one or more processors 310 and memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. However, the components may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage device 340 operates in conjunction with a portable non-volatile storage medium, such as a floppy disk, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 receives textual and graphical information, and processes the information for output to the display device.

Peripherals 380 may include any type of computer support device to add additional functionality to the computer system. For example, peripheral device(s) 380 may include a modem or a router.

The components contained in the computer system 300 of FIG. 3 are those typically found in computer systems that may be suitable for use with embodiments of the present invention and are intended to represent a broad category of such computer components that are well known in the art. Thus, the computer system 300 of FIG. 3 can be a personal computer, handheld computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A system for automated workflows for utility asset exchanges, the system comprising:
a trust system that:
receive information regarding a utility asset sent from a developer system over a communication network, and
register the utility asset within a registry database, wherein registering the utility asset includes creating one or more shares uniquely linked to the utility asset and translating a quantified value associated with the utility asset into the created shares; and
a platform server that:
receives information regarding the shares from the trust system,
maintains an online order book that tracks status of the shares linked to the utility asset, and
automatically initiates removal of the utility asset from the trust system when the tracked status of the shares indicates redemption of the utility asset.

2. The system of claim 1, wherein the platform server further automatically issues a redemption certificate when the tracked status of the shares indicates redemption of the utility asset.

3. The system of claim 1, wherein the platform server further receives redemption data from a device associated with the shares.

4. The system of claim 1, wherein the trust system translates the utility asset into the created shares by determining a share equivalence ratio and further tracks the utility asset in association with the translated shares and the determined share equivalence ratio.

5. The system of claim 1, wherein the trust system removes one or more of the shares from the registry database in accordance with the share equivalence ratio.

6. The system of claim 1, wherein the trust system further prevents duplicate redemption of the utility asset based on registry database.

7. The system of claim 1, wherein the quantified value of the utility asset includes a unit of the utility asset and a standardized definition for the unit, and the trust system registers the utility asset by creating a new record within the registry database to store the unit of the utility asset.

8. The system of claim 1, wherein the status of the shares includes current ownership information for the shares linked to the utility asset, and wherein the platform server further communicates the current ownership information to the trust system for recordation in the registry database.

9. The system of claim 8, wherein the trust system removes the utility asset and the associated shares from the registry database further based on the current ownership information.

10. A method for automated workflows for utility asset exchanges, the method comprising:
receiving information regarding a utility asset sent from a developer system to a trust system over a communication network;
registering the utility asset within a registry database, wherein registering the utility asset includes creating one or more shares uniquely linked to the utility asset and translating a quantified value associated with the utility asset into the created shares;
maintaining an online order book that tracks status of the shares linked to the utility asset; and
automatically initiating removal of the utility asset from the trust system when the tracked status of the shares indicates redemption of the utility asset.

11. The method of claim 10, further comprising automatically issuing a redemption certificate when the tracked status of the shares indicates redemption of the utility asset.

12. The method of claim 10, further comprising receiving redemption data from a device associated with the shares.

13. The method of claim 10, wherein translating the utility asset into the created shares includes determining a share equivalence ratio, and further comprising tracking the utility asset in association with the translated shares and the determined share equivalence ratio.

14. The method of claim 10, wherein removing one or more of the shares from the registry database is based on the share equivalence ratio.

15. The method of claim 10, further comprising preventing duplicate redemption of the utility asset based on registry database.

16. The method of claim 10, wherein the quantified value of the utility asset includes a unit of the utility asset and a standardized definition for the unit, and wherein registering the utility asset includes creating a new record within the registry database to store the unit of the utility asset.

17. The method of claim 10, wherein the status of the shares includes current ownership information for the shares linked to the utility asset, and further comprising obtaining the current ownership information to the trust system for recordation in the registry database.

18. The system of claim 17, wherein removing the utility asset and the associated shares from the registry database is further based on the current ownership information.

19. A non-transitory, computer-readable storage medium, having embodied thereon a program executable by a processor to perform a method for automated workflows for utility asset exchanges, the method comprising:
receiving information regarding a utility asset sent from a developer system to a trust system over a communication network;
registering the utility asset within a registry database, wherein registering the utility asset includes creating one or more shares uniquely linked to the utility asset and translating a quantified value associated with the utility asset into the created shares;
maintaining an online order book that tracks status of the shares linked to the utility asset; and
automatically initiating removal of the utility asset from the trust system when the tracked status of the shares indicates redemption of the utility asset.
